(19) United States
(12) Patent Application Publication
(10) Pub. No.: US 2011/0127968 A1
(43) Pub. Date: Jun. 2, 2011

(54) Method Of Managing A Rechargeable Battery For An Electronic Device

(76) Inventors: Chia-Han Chan, Taipei (TW); Chuan-Rung Wang, Taipei (TW); Shin-Wei Chen, Taipei (TW)

(21) Appl. No.: 12/626,937

(22) Filed: Nov. 29, 2009

(51) Int. Cl. H02J 7/00

(52) U.S. Cl. 320/136

(57) ABSTRACT

A method for managing a rechargeable battery set coupled to an electronic device comprises steps of obtaining a temperature of the rechargeable battery set; obtaining a remainder capacity of the rechargeable battery set; sending a first signal to indicate the electronic device to receive power from the rechargeable battery set if the temperature of the rechargeable battery set exceeding a threshold of temperature and the remainder capacity of the rechargeable battery set exceeding a threshold of capacity. The method prevents the rechargeable battery 4 from a condition of high temperature and high remainder capacity to prevent the rechargeable battery 4 from deterioration.

### BACKGROUND OF THE INVENTION

1. Field of the Invention

The present invention relates to a method of managing a rechargeable battery, more specifically, to a method for managing a rechargeable battery set of an electronic device to prevent the rechargeable battery from deterioration.

2. The Related Art

Nowadays, electronic devices, such as laptop computers, mobile phones, PDAs, become more compact for saving space and conveniently hand carry. In order to improve mobility, the electronic devices equip a rechargeable battery.

Please refer to FIG. 1, it shows a block diagram of the laptop computer 1. The laptop computer 1 has a main body 2, a rechargeable battery 4 and a power adapter 6. Specially, the rechargeable battery 4 is a lithium battery. The power adapter 6 is an AC adapter. The main body 2 has a processor unit 8, an input unit 10, an output unit 12, a power converter unit 14 and a charging unit 16. Specially, the power converter unit 14 is a DC/DC converter having a first converting section 18 and a second converting section 20.

The main body 2 connects to the rechargeable battery 4 and the power adapter 6. The power adapter 6 transfers AC power into DC power and then supplies DC power to the charging unit 16. The charging unit 16 converts DC power into a charging power for charging the rechargeable battery 4.

The rechargeable battery 4 supplies a discharging power to the first converting section 18 of the power converter unit 14. The first converting section 18 converts the discharging power into an available power and then supplies the available power to the processor unit 8, the input unit 10 and the output unit 12 respectively. Specially, the first converting section 18 is a step down circuit. The input unit 10 can be a keyboard, a mouse, a touch pad, a microphone, etc. The output unit can be a display screen, a speaker, etc. The processor unit 8 can be a keyboard controller (KBC), a programmable chip, etc.

The second converting section 20 converts DC power received from the power adapter 6 into the available power and then supplies the available power to the processor unit 8, the input unit 10 and the output unit 12 respectively. Specially, the second converting section 20 is a step down circuit.

Please refer to FIG. 2, it shows a conventional method for managing the rechargeable battery 4 of the laptop computer 1. The method includes:
Step 901: Booting the laptop computer 1.
Step 902: The processor unit 8 judges whether the main body 2 connects to an outlet through the power adapter 6. If the main body 2 connects to the outlet through the power adapter 6, then step 903 will be executed, else step 907 will be executed.
Step 903: The processor unit 8 determines that the laptop computer 1 receives power through which one of the following device: the outlet, the power adapter 6 and the section converting section 20.
Step 904: The processor unit 8 judges whether the capacity of the rechargeable battery 4 is full. If the capacity of the rechargeable battery 4 is full, then step 905 will be executed, else step 906 will be executed.
Step 905: The processor unit 8 controls the charging unit 16 to stop supplying the charging power to the rechargeable battery 4. Then step 902 will be repeated.
Step 906: The processor unit 8 controls the charging unit 16 to supply the charging power to the rechargeable battery 4. Then step 904 will be repeated.
Step 907: The processor controls the first converting section 18 to supply the available power to the laptop computer 1, which is discharged by the rechargeable battery 4 and then converted by the first converting section 18.
Step 908: The processor unit 8 judges whether the capacity of the rechargeable battery 4 is below a threshold. If the capacity of the rechargeable battery 4 is below the threshold, then step 909 will be executed, else step 907 will be repeated.
Step 909: The processor unit 8 sends a signal to indicate the capacity of the rechargeable battery 4 is too low and the effect the laptop computer 1 to enter a sleep mode. Then repeat the step 901.
However, the temperature of the main body 2 will raised after the laptop computer 1 has been working a long time. The high temperature of the main body 2 passes to the rechargeable battery 4 and then the temperature of the rechargeable battery 4 will be also raised. If the rechargeable battery 4 is in a condition of high temperature and high capacity, the rechargeable battery 4 will deteriorate rapidly. Hence, the life of the rechargeable battery 4 will be shortened.

### SUMMARY OF THE INVENTION

An object of the present invention is to provide a method of managing rechargeable battery capable of holding a rechargeable battery in an appropriate condition for preventing rechargeable battery from deterioration.

According to the invention, the method for managing the rechargeable battery set coupled to an electronic device comprises steps of obtaining a temperature of the rechargeable battery set; obtaining a remainder capacity of the rechargeable battery set; sending a first signal to indicate the electronic device to receive power from the rechargeable battery set if the temperature of the rechargeable battery set exceeding a threshold of temperature and the remainder capacity of the rechargeable battery set exceeding a threshold of capacity.

According to the invention, The electronic device alternately receives an available power from a first path of receiving AC power from an outlet and then transforming AC power into DC power by an AC adapter and then converting DC power into the available power by a DC/DC converter, and a second path of receiving a discharging power from the rechargeable battery set and then converting the discharging power into the available power by the DC/DC converter.

The method comprises steps of obtaining a temperature of the rechargeable battery set; obtaining a remainder capacity of the rechargeable battery set; receiving the available power by the electronic device from the second path if the temperature of the rechargeable battery set exceeding a threshold of temperature and the remainder capacity of the rechargeable battery set exceeding a threshold of capacity.

Hence, the method can prevent the rechargeable battery 4 from a condition of high temperature and high remainder capacity. The rechargeable battery 4 is prevented from deterioration for extending life thereof.

### BRIEF DESCRIPTION OF THE DRAWINGS

The present invention will be apparent to those skilled in the art by reading the following description of preferred embodiments thereof, with reference to the attached drawings, in which:

FIG. 1 shows a block diagram of a laptop computer according to the present invention;

FIG. 2 shows a flow chart of a conventional method for managing a rechargeable battery of the laptop computer;

FIG. 3 shows a flow chart of a first preferred method for managing the rechargeable battery according to the present invention;

FIG. 4 shows a flow chart of a second preferred method for managing the rechargeable battery according to the present invention;

FIG. 5 shows a flow chart of a third preferred method for managing the rechargeable battery according to the present invention; and

FIG. 6 shows a characteristic table of comparison between a threshold of capacity and a threshold of temperature.

### DETAILED DESCRIPTION OF THE PREFERRED EMBODIMENT

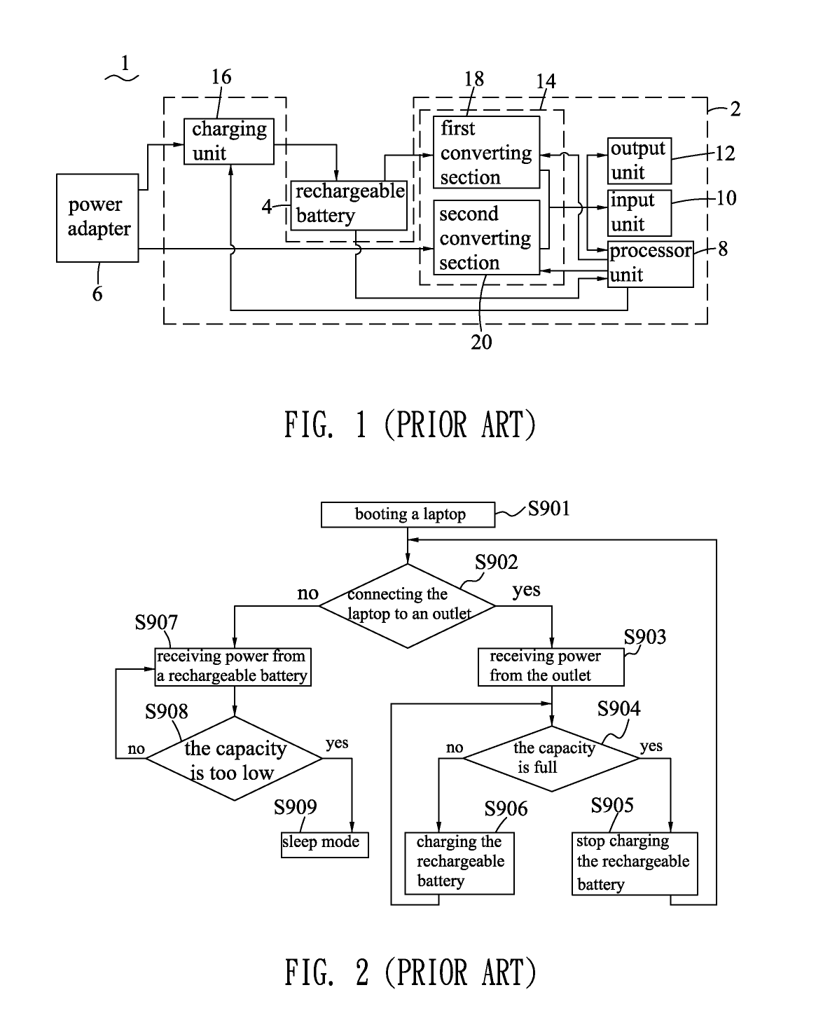

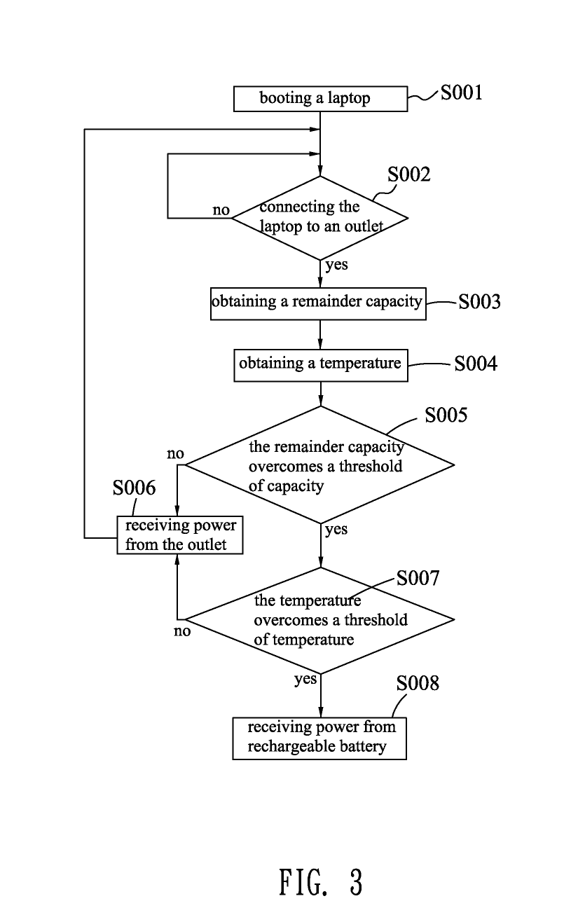

Please refer to FIG. 3, it shows a first preferred embodiment of a method for managing a rechargeable battery. The method can apply to various electronic devices, such as laptop computers, PDAs, mobile phones, etc. In this embodiment, the method applies to the laptop computer 1 (shown in FIG. 1) has following steps.

In step S001, the laptop computer 1 is booted. In step S002, the processor unit 8 judges whether the main body 2 connects to an outlet through the power adapter 6. If the main body 2 connects to the outlet through the power adapter 6, step 003 will be executed, else step 002 will be repeated. In step S003, the processor unit 8 obtains a remainder capacity of the rechargeable battery 4. In step S004, the processor unit 8 obtains a temperature of the rechargeable battery 4.

In step S005, the processor unit 8 judges whether the remainder capacity of the rechargeable battery 4 exceeds a threshold of capacity. If the remainder capacity of the rechargeable battery 4 exceeds the threshold of capacity, step S007 will be executed, else step S006 will be executed. In 5006, the processor unit 8 controls the power converter unit 14 to supply the available power which is supplied from the outlet and then transferred by the power adapter 6 and then converted by the second converting section 20.

In step S007, the processor unit 8 judges whether the temperature of the rechargeable battery 4 exceeds a threshold of temperature. If the temperature of the rechargeable battery 4 exceeds the threshold of temperature, step S008 will be executed, else step S006 will be repeated. In step S008, the processor unit 8 controls the power converter unit 14 to supply the available power which is supplied from the rechargeable battery 4 and then converted by the first converting section 18. Then step S002 will be repeated.

Hence, the processor unit 8 controls the rechargeable battery 4 in a condition of discharging until the temperature of the rechargeable battery 4 is below the threshold of temperature or the remainder capacity of the rechargeable battery 4 is below the threshold of capacity, if the temperature of the rechargeable battery 4 exceeds the threshold of temperature and the remainder capacity of the rechargeable battery 4 exceeds the threshold of capacity.

Specially, step S003 and step S004 can be exchanged. Step S005 and step S007 can be exchanged. While the step S008 is finished, step S003 can be repeated.

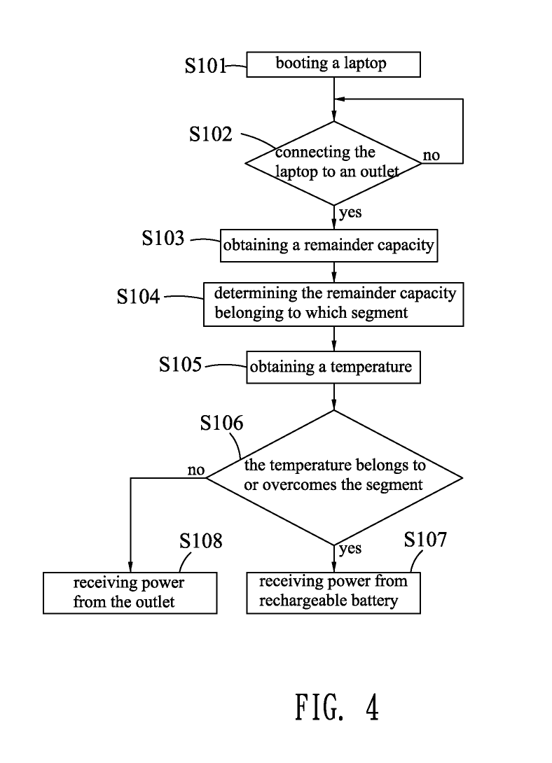

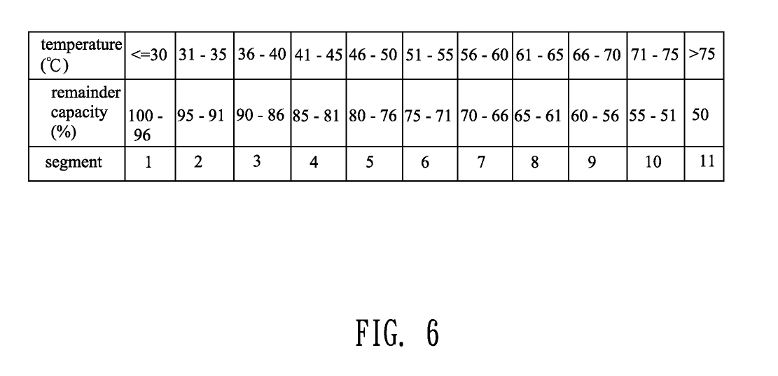

Please refer to FIG. 4 and FIG. 6. FIG. 4 shows a second preferred embodiment of a method for managing the rechargeable battery 4. FIG. 6 shows a characteristic table of comparison between the threshold of capacity and the threshold of temperature. The threshold of capacity and the threshold of temperature are segmented into a plurality of the segments. Each of the segments has a range of capacity and a range of temperature.

The method comprises following steps. In step S101, the laptop computer 1 is booted. In step S102, the processor unit 8 judges whether the main body 2 connects to an outlet through the power adapter 6. If the main body 2 connects to the outlet through the power adapter 6, then step 103 will be executed, else step 102 will be repeated.

In step S103, the processor unit 8 obtains the remainder capacity of the rechargeable battery 4. In step S104, the processor unit 8 judges the remainder capacity of the rechargeable battery 4 is belonged to which segment. For instance, if the remainder capacity of the rechargeable battery 4 is 90 percentages, the remainder capacity of the rechargeable battery 4 is belonged to segment 3 of which range is from 86 percentages to 90 percentages. The range of temperature in segment 3 is from 36° C. to 40° C.

In step 105, the processor unit 8 obtains the temperature of the rechargeable battery 4. In step 106, the processor unit 8 judges whether the temperature of the rechargeable battery 4 is belonged to segment 3 or exceeds the temperature of the segment 3. If the temperature of the rechargeable battery 4 is belonged to segment 3 or exceeds the temperature of the segment 3, then step S107 will be executed, else step S108 will be executed.

In step S107, the processor unit 8 controls the power converter unit 14 to supply the available power which is supplied from the rechargeable battery 4 and then converted by the first converting section 18. Then step S103 is repeated. In step S108, the processor unit 8 controls the power converter unit 14 to supply the available power which is supplied from the outlet and then transferred by the power adapter 6 and then converted by the second converting section 20. Then step S103 will be repeated.

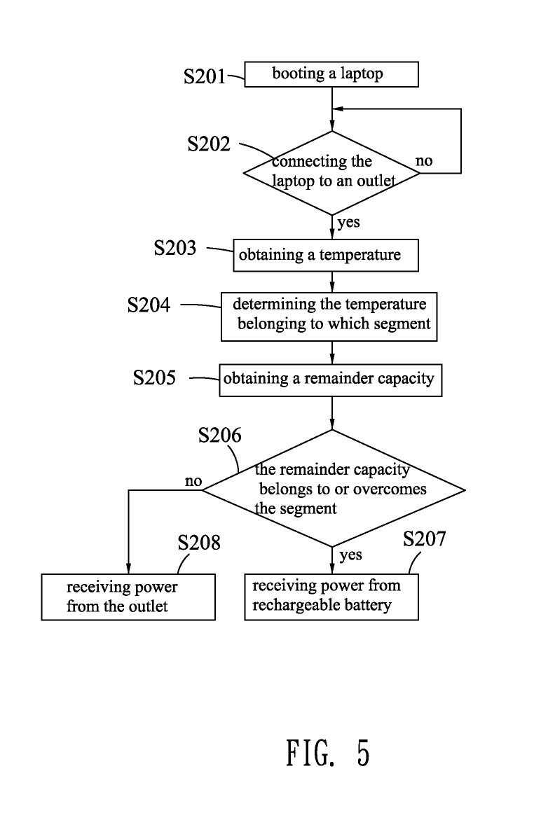

Please refer to FIG. 5, it shows a third preferred embodiment of a method for managing the rechargeable battery 4. The method comprises following steps. In step S201, the laptop computer 1 is booted. In step S202, the processor unit 8 judges whether the main body 2 connects to an outlet through the power adapter 6. If the main body 2 connects to the outlet through the power adapter 6, then step 203 will be executed, else step 202 will be repeated.

In step S203, the processor unit 8 obtains the temperature of the rechargeable battery 4. In step S204, the processor unit 8 judges the temperature of the rechargeable battery 4 is belonged to which segment. For instance, if the temperature of the rechargeable battery 4 is 44° C., the temperature of the rechargeable battery 4 is belonged to segment 4 of which range is from 41° C. to 45° C. The range of capacity in segment 4 is from 85 percentages to 81 percentages.

In step 205, the processor unit 8 obtains the remainder capacity of the rechargeable battery 4. In step 206, the processor unit 8 judges whether the reminder capacity of the rechargeable battery 4 is belonged to segment 4 or exceeds the capacity of the segment 4. If the remainder capacity of the rechargeable battery 4 is belonged to segment 4 or exceeds the capacity of the segment 4, then step S207 will be executed, else step S208 will be executed.

In step S207, the processor unit 8 controls the power converter unit 14 to supply the available power which is supplied from the rechargeable battery 4 and then converted by the first converting section 18. Then step S203 is repeated. In step S208, the processor unit 8 controls the power converter unit 14 to supply the available power which is supplied from the outlet and then transferred by the power adapter 6 and then converted by the second converting section 20. Then repeat step S203.

Specially, the table may be calculated according to experience. The table may be calculated according to temperature curved of the rechargeable battery 4. Therefore, each kind of rechargeable batteries has itself temperature curved and characteristic table.

If the remainder capacity of the rechargeable 4 is high, the temperature of the rechargeable battery 4 should be set to low for preventing the rechargeable battery 4 from deterioration. That is to say, if the temperature of the rechargeable battery 4 is raised, the remainder capacity of the rechargeable battery 4 should be decreased.

As described above, if the temperature of the rechargeable battery 4 exceeds the threshold of temperature and the remainder capacity of the rechargeable battery 4 exceeds the threshold of capacity, the processor unit 8 controls the power converter unit 14 to receive and convert the discharge power from the rechargeable battery 3 and then supply the available power to the laptop computer 1 until the temperature of the rechargeable battery 4 is below the threshold of temperature or the remainder capacity of the rechargeable battery 4 is below the threshold of capacity.

Hence, the method can prevent the rechargeable battery 4 from the condition of high temperature and high remainder capacity. The rechargeable battery 4 can be prevented from deterioration for extending life thereof.

Furthermore, the present invention is not limited to the embodiments described above; diverse additions, alterations and the like may be made within the scope of the present invention by a person skilled in the art. For example, respective embodiments may be appropriately combined.

What is claimed is:

1. A method for managing a rechargeable battery set coupled to an electronic device, comprising:
obtaining a temperature of the rechargeable battery set;
obtaining a remainder capacity of the rechargeable battery set;
sending a first signal to indicate the rechargeable battery set to supply power to the electronic device if the temperature of the rechargeable battery set exceeding a threshold of temperature and the remainder capacity of the rechargeable battery set exceeding a threshold of capacity.

2. The method for managing a rechargeable battery set claimed in claim 1, further comprising sending a second signal to indicate the electronic device to receive power from an outlet if the temperature of the rechargeable battery set being below the threshold of temperature and the remainder capacity of the rechargeable battery set being below the threshold of capacity.

3. The method for managing a rechargeable battery set claimed in claim 2, further comprising:
segmenting the threshold of temperature into a plurality of temperature segments;
segmenting the threshold of capacity into a plurality of capacity segments;
setting each of temperature segments with a corresponding capacity segment;
judging the temperature of the rechargeable battery set belonging to which temperature segments;
judging whether the remainder capacity of the rechargeable battery set belonging to or exceeding one of the capacity segments corresponding to the temperature segment;
sending the first signal if the remainder capacity of the rechargeable battery set belonging to or exceeding the capacity segment;
sending the second signal if the remainder capacity of the rechargeable battery set being below the capacity segment.

4. The method for managing a rechargeable battery set claimed in claim 2, further comprising:
segmenting the threshold of temperature into a plurality of temperature segments;
segmenting the threshold of capacity into a plurality of capacity segments;
setting each of temperature segments with a corresponding capacity segment;
judging the temperature of the rechargeable battery set belonging to which temperature segments;
judging whether the remainder capacity of the rechargeable battery set exceeding one of the capacity segments corresponding to the temperature segment;
sending the first signal if the remainder capacity of the rechargeable battery set exceeding the capacity segment;
sending the second signal if the remainder capacity of the rechargeable battery set belonging to or being below the capacity segment.

5. The method for managing a rechargeable battery set claimed in claim 2, further comprising:
segmenting the threshold of temperature into a plurality of temperature segments;
segmenting the threshold of capacity into a plurality of capacity segments;
setting each of temperature segments with a corresponding capacity segment;
judging the remainder capacity of the rechargeable battery set belonging to which capacity segments;
judging whether the temperature of the rechargeable battery set belonging to or exceeding one of the temperature segments corresponding to the capacity segment;
sending the first signal if the temperature of the rechargeable battery set belonging to or exceeding the temperature segment;
sending the second signal if the temperature of the rechargeable battery set being below the temperature segment.

6. The method for managing a rechargeable battery set claimed in claim 2, further comprising:
segmenting the threshold of temperature into a plurality of temperature segments;
segmenting the threshold of capacity into a plurality of capacity segments;
setting each of temperature segments with a corresponding capacity segment;
judging the remainder capacity of the rechargeable battery set belonging to which capacity segments;
judging whether the temperature of the rechargeable battery set exceeding one of the temperature segments corresponding to the capacity segment;
sending the first signal if the temperature of the rechargeable battery set exceeding the temperature segment;
sending the second signal if the temperature of the rechargeable battery set belonging to or being below the temperature segment.

7. The method for managing a rechargeable battery set claimed in claim 2, wherein a processor unit of the electronic device obtains the temperature and the remainder capacity of the rechargeable battery set and sends the first signal and the second signal.

8. The method for managing a rechargeable battery set as claimed in claim 1, wherein the rechargeable battery set is a lithium battery.

9. The method for managing a rechargeable battery set as claimed in claim 8, wherein the electronic device is a laptop computer.

10. A method for managing a rechargeable battery set coupled to an electronic device alternately receiving an available power from a first path of receiving AC power from an outlet and then transforming AC power into DC power by an AC adapter and then converting DC power into the available power by a DC/DC converter, and a second path of receiving a discharging power from the rechargeable battery set and then converting the discharging power into the available power by the DC/DC converter, comprising:
obtaining a temperature of the rechargeable battery set;
obtaining a remainder capacity of the rechargeable battery set;
receiving the available power by the electronic device from the second path if the temperature of the rechargeable battery set exceeding a threshold of temperature and the remainder capacity of the rechargeable battery set exceeding a threshold of capacity.

11. The method for managing a rechargeable battery set claimed in claim 10, wherein receiving the available power by the electronic device from the first path if the temperature of the rechargeable battery set is below the threshold of temperature or the remainder capacity of the rechargeable battery set is below the threshold of capacity.

12. The method for managing a rechargeable battery set claimed in claim 11, further comprising:
segmenting the threshold of temperature into a plurality of temperature segments;
segmenting the threshold of capacity into a plurality of capacity segments;
setting each of temperature segments with a corresponding capacity segments;
judging the temperature of the rechargeable battery belonging to which temperature segment;
judging whether the remainder capacity of the rechargeable battery belonging to or exceeding one of the capacity segments corresponding to the temperature segment;
receiving the available power from the second path if the remainder capacity of the rechargeable battery set belonging to or exceeding the capacity segment;
receiving the available power from the first path if the remainder capacity of the rechargeable battery set being below the capacity segment.

13. The method for managing a rechargeable battery set claimed in claim 11, further comprising:
segmenting the threshold of temperature into a plurality of temperature segments;
segmenting the threshold of capacity into a plurality of capacity segments;
setting each of temperature segments with a corresponding capacity segment;
judging the temperature of the rechargeable battery belonging to which temperature segments;
judging whether the remainder capacity of the rechargeable battery exceeding one of the capacity segments corresponding to the temperature segment;
receiving the available power from the second path if the remainder capacity of the rechargeable battery set exceeding the capacity segment;
receiving the available power from the second path if the remainder capacity of the rechargeable battery set belonging to or being below the capacity segment.

14. The method for managing a rechargeable battery set claimed in claim 11, further comprising:
segmenting the threshold of temperature into a plurality of temperature segments;
segmenting the threshold of capacity into a plurality of capacity segments;
setting each of temperature segments with a corresponding capacity segment;
judging the remainder capacity of the rechargeable battery belonging to which capacity segments;
judging whether the temperature of the rechargeable battery belonging to or exceeding one of the temperature segments corresponding to the capacity segment;
receiving the available power from the second path if the temperature of the rechargeable battery set belonging to or exceeding the temperature segment;
receiving the available power from the first path if the temperature of the rechargeable battery set being below the temperature segment.

15. The method for managing a rechargeable battery set claimed in claim 11, further comprising:
segmenting the threshold of temperature into a plurality of temperature segments;
segmenting the threshold of capacity into a plurality of capacity segments;
setting each of temperature segments with a corresponding capacity segment;
judging the remainder capacity of the rechargeable battery belonging to which capacity segments;
judging whether the temperature of the rechargeable battery exceeding one of the temperature segments corresponding to the capacity segment;
receiving the available power from the second path if the temperature of the rechargeable battery set exceeding the temperature segment;
receiving the available power from the first path if the temperature of the rechargeable battery set belonging to or being below the temperature segment.

16. The method for managing a rechargeable battery set claimed in claim 11, wherein a processor unit of the electronic device obtains the temperature and the remainder capacity of the rechargeable battery set and controls the DC/DC converter to alternately receive the DC power from the AC adapter and the discharging power from the rechargeable battery set.

17. The method for managing a rechargeable battery set as claimed in claim 10, wherein the rechargeable battery is a lithium battery.

18. The method for managing a rechargeable battery set as claimed in claim 17, wherein the electronic device is a laptop computer.
